(19) United States
(12) Patent Application Publication
(10) Pub. No.: US 2026/0338659 A1
(43) Pub. Date: Oct. 29, 2026

(54) Optical Device for Detecting the Concentration of Nano-scale Particles and Detection Method Thereof

(71) Applicant: Dandong Bettersize Instruments Ltd., Dandong City, Liaoning Province (CN)

(72) Inventors: Xiaoguang LI, Dandong (CN); Hongyu YANG, Dandong (CN); Yueqiang LIU, Dandong (CN); Quanwei CHEN, Dandong (CN); Hui NING, Dandong (CN); Xiaoxu LI, Dandong (CN); Hao ZHENG, Dandong (CN)

(21) Appl. No.: 19/119,760

(22) PCT Filed: Oct. 22, 2024
(86) PCT No.: PCT/CN2024/126312

§ 371 Date: Apr. 9, 2025

(30) Foreign Application Priority Data
Oct. 31, 2023 (CN) 202311423749.2

(51) Int. Cl. G01N 15/075

(52) U.S. Cl. CPC G01N 15/075

(57) ABSTRACT

The present invention discloses an optical device for detecting the concentration of nano-scale particles and a detection method thereof, which includes a sample pool, a rotating wheel equipped with neutral density filters, an APD detector, a PD detector, a laser, a lens, a data acquisition card and a control unit, wherein the laser emitted by the laser device is irradiated onto the sample in the sample pool through the lens, and the intensity of the transmitted light is detected by the PD detector in the transmission direction, and the scattered signal of the sample is received by the APD detector connected to the optical fiber at 90° or backward. The method is: detecting a volume fraction Φ of the sample through the extinction method by using the signal of the transmitted light intensity; detecting a particle size distribution of the sample by using dynamic light scattering; then calculating a volume fraction Φi and a number concentration of each particle size peak by using the volume fraction Φ and the particle size distribution. The present invention combines the extinction method and the dynamic light scattering method to realize the detection of the volume concentration and number concentration of the sample.

### FIELD OF INVENTION

The present invention relates to the technical field of optical method for detecting concentration of nano-scale particles, and in particular to an optical device for detecting the concentration of nano-scale particle and a detection method thereof.

### DESCRIPTION OF RELATED ARTS

The particle concentration measurement in nanoparticle suspensions is used in many industries and fields. For example, it can be used for quality control in the production process of chemical products, detecting the reproduction and spread of bacteria, and measuring the concentration of viruses in the blood to make better and more timely and effective diagnosis of the patient's condition, etc. The determination of particle concentration provides important information for scientific research, production processes, medical testing, and food safety.

There are many methods for testing the concentration of nanoparticle suspensions, such as UV spectrophotometry, nano-Coulter method, extinction method, nanoparticle tracking analysis technology, multi-angle dynamic light scattering method, etc. However, most of these methods have certain limitations in detecting particle concentration. For example, UV spectrophotometry detects the overall mass/volume concentration of the sample and cannot provide information on concentration distribution, volume fraction, and number concentration; the nano-Coulter method can obtain the sample number concentration information, but the sample must be dispersed in an electrolyte dispersion; the extinction method can only give the volume fraction of the sample, but cannot give the concentration distribution information and number concentration information; the nanoparticle tracking technology can provide information on number concentration, but its sensitivity is limited and it is not effective for detecting particles below 50 nm; the multi-angle dynamic light scattering method requires the use of a material with a known Rayleigh ratio to calibrate the detector solid angle of the optical system before detection.

### SUMMARY OF THE PRESENT INVENTION

In view of the existing technologies have insufficient and limited detection capability to detect particle concentration in nanoparticle suspensions, the problems to be solved by the present invention is to provide an optical device for detecting concentration and concentration distribution of nano-scale particle and a detection method thereof, specifically an optical device for detecting the concentration of nano-scale particle and a detection method thereof, which is an optical device for detecting the concentration of nano-scale particle and a detection method thereof that combines the extinction method with the dynamic light scattering method (Light Extinction combined Dynamic Light Scattering, LEDLS).

In order to solve the above technical problems, the technical solution adopted by the present invention is as follows:
An optical device for detecting concentration of nano-scale particle, which is an optical device that combines an extinction method and a dynamic light scattering method to detect the concentration of nanoparticles, the optical device comprises a sample pool, a rotating wheel, an APD detector, an PD detector, a laser device, a lens, a data acquisition card, a control unit and a microprocessor having a signal input terminal receiving instructions from the control unit, and an output terminal outputting control signals connected to a motor control loop;
an incident light beam of said laser device is irradiated onto a sample in said sample pool through a neutral density filter and a lens, said neutral density filter is arranged to adjust an intensity of the incident light beam, and the lens is arranged to converge the light beam;
in a light path, neutral density filters are installed in said rotating wheel, ten number of neutral density filters with different attenuation rates and one light-transmitting hole without filter installed are installed on the rotating wheel, said neutral density filters or said light-transmitting hole without filter installed thereon of said rotating wheel is arranged in the incident light path by rotating the motor;
a scattered light signal of the sample is received by said APD detector connected to said optical fiber at 90° or backward; and
said PD detector is placed in a 0° direction of laser incidence to detect an intensity of the transmitted laser.

According to a preferred embodiment of the optical device for detecting concentration of nano-scale particle, said sample pool has a square or rectangular cross section, wherein opposite sides are parallel.

According to a preferred embodiment of the optical device for detecting concentration of nano-scale particle, said ten neutral density filters with different attenuation rates and said one light-transmitting hole without filter installed thereon can adjust a light transmission from 100% to one millionth of the light transmission.

According to a preferred embodiment of the optical device for detecting concentration of nano-scale particle, in a process of detecting I₀ and detecting the original scattered light signal, said rotating wheel is automatically adjusted by the motor to select an appropriate neutral density filter to adjust an intensity of the incident laser beam, so that the transmitted light I₀ is within a linear response range of said PD detector, and the original scattered light signal is within a linear response range of said APD.

A detection method of the optical device for detecting concentration of nano-scale particle includes the steps as follows:
Step 1: collecting the original scattered light signal by said APD detector, processing calculation of correlation function, and performing multi-exponential fitting on the correlation function to obtain a particle size intensity distribution of the particles in the sample, and by combining a wavelength of the laser, a known refractive index of the particles and a refractive index of a dispersant with Mie theory, converting the intensity distribution into volume distribution, area distribution and number distribution, and the corresponding distribution intensities are all relative values;
Step 2: calculating an average surface area diameter D_{3,2} of the sample through the area distribution; and calculating an average particle size Dᵢ of each particle size peak through the volume distribution;
Step 3: collecting light intensity I₀ in the transmission direction of the laser beam through a blank dispersant and light intensity I_{T} in the transmission direction after passing through the sample by said PD detector, calculating an extinction coefficient Qe through combining the laser wavelength, the known refractive index of the particles, the refractive index of the dispersant and D_{3,2} with Mie theory, and calculating a volume fraction Φ of the sample by Qe and D_{3,2} through the extinction method;
Step 4: calculating a volume fraction (Dᵢ of each particle size peak by combining the area content of each particle size peak calculated from the volume distribution and the sample volume fraction;
Step 5: calculating a number concentration of each particle size peak by combining the average particle size within each particle size peak and volume fraction of each peak.

The beneficial effects and advantages of the present invention are as follows:
1. The present invention combines the extinction method and the dynamic light scattering method to realize the detection of the volume concentration and number concentration of the sample. The device has good promotion and practical value, and will produce good economic and social benefits after extensive promotion and application.
2. The present invention is easy to operate and does not require the use of any material with known scattering ability and Rayleigh ratio to calibrate the system before detection.
3. The present invention can be widely used in precision electrical, electronics, instrumentation and other products, and is mainly used in medical and health, biopharmaceuticals, agricultural research, environmental protection and other research and application fields.

### BRIEF DESCRIPTION OF THE DRAWINGS

FIG. 1 is a schematic electrical diagram of an optical device for detecting concentration and concentration distribution of nano-scale particles and its detection method thereof according to the present invention.

FIG. 2 is a schematic structural diagram showing the 90° scattered light detection optical path according to the present invention.

FIG. 3 is a schematic structural diagram showing the optical path for backward detection of scattered light according to the present invention.

FIG. 4 illustrates a schematic diagram of a rotating wheel equipped with a neutral density filter according to the present invention.

FIG. 5 illustrates a flow chart for calculating the surface area average particle size D_{3,2} according to the present invention.

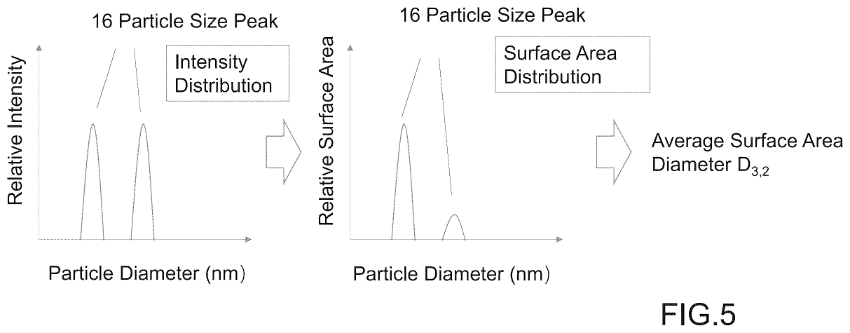

FIG. 6 illustrates a schematic diagram of calculating the volume fraction Φi and number concentration according to the present invention.

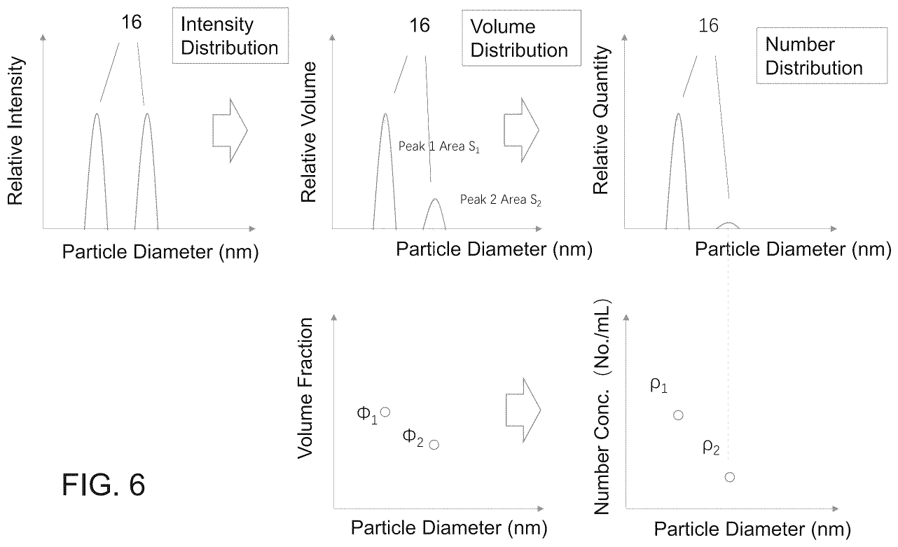

Wherein 1 refers to a laser device, 2 refers to lens, 3 refers to a sample, 4 refers to a sample pool, 5 refers to a PD detector, 6 refers to 90° scattered light, 7 refers to a fiber head connected to an APD detector, 8 refers to an optical fiber, 9 refers to backscattered light, 10 refers to a rotating wheel equipped with neutral density filters, 11 refers to a motor, 12 refers to a neutral density filter, 13 refers to a shaft, 14 refers to a rotating wheel, 15 refers to a light-transmitting hole without filter installed, 16 refers to particle size peak, and 17 refers to transmitted light.

### DETAILED DESCRIPTION OF THE PREFERRED EMBODIMENT

The present invention will be further described below in conjunction with the accompanying drawings.

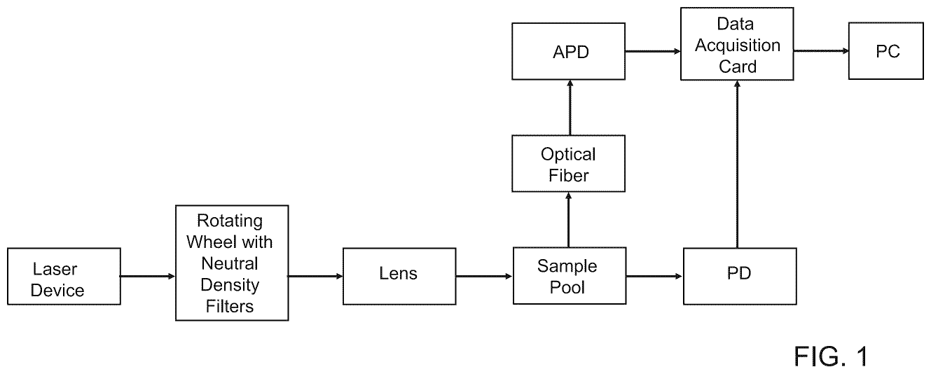

Referring to FIG. 1 of the drawings, the present invention provides an optical device and method for detecting the concentration of nano-scale particles. The optical device includes a sample pool 4, a rotating wheel equipped with a neutral density filters 10, an APD detector, a PD detector 5, a laser device, a lens 2, a data acquisition card, and a control unit.

The present invention also comprises a microprocessor, the microprocessor comprising a signal input terminal receiving the command of the control unit, and an output terminal outputting a control signal connected to a control loop of a motor 11.

The sample pool 4 has a square or rectangular cross section, wherein opposite sides are parallel.

The incident light beam 1 of the laser device is irradiated onto a sample 3 in the sample pool 4 through the neutral density filter 10 and the lens 2, and the lens 2 has a converging effect on the light beam.

The PD detector 5 is placed at the 0° direction of laser incidence to detect the intensity of the transmitted light 17.

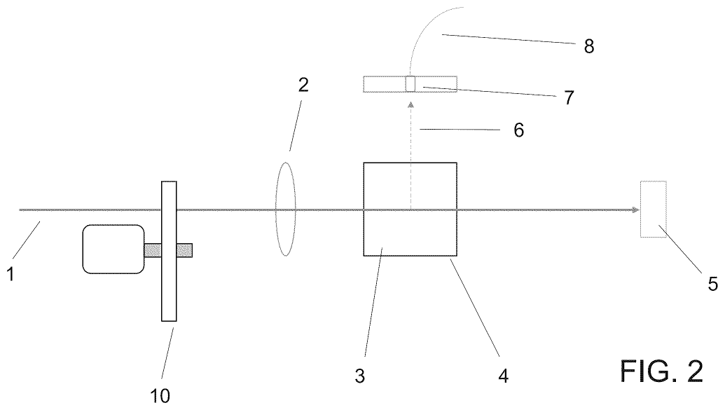

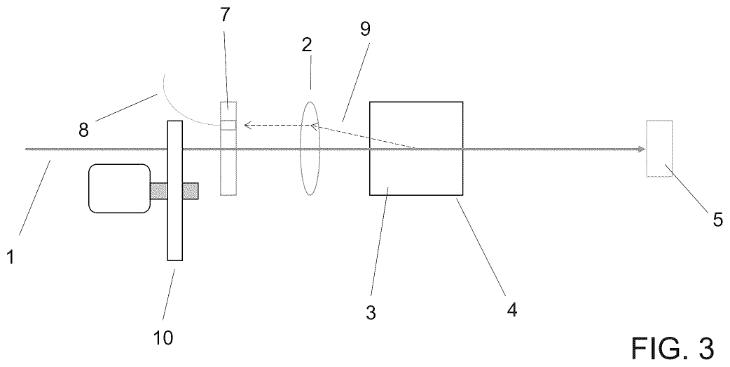

Referring to FIG. 2 and FIG. 3, the APD detector 7 connected to the optical fiber receives the signal of the scattered light 7 of the sample at 90 degrees or receives the signal of the scattered light 9 of the sample 3 in the backward direction.

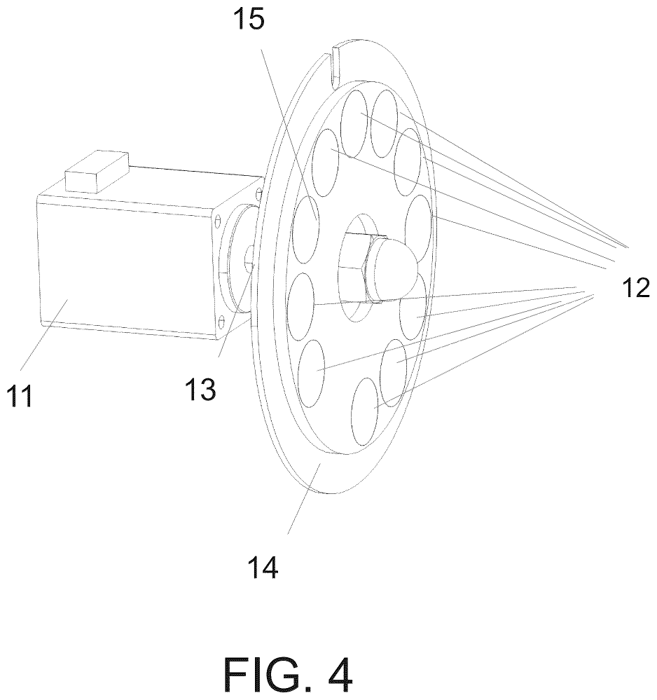

Referring to FIG. 4 of the drawings, a rotating wheel equipped with neutral density filter 10 is installed in the optical path, and ten number of neutral density filters 12 with different attenuation rates and one light-transmitting hole 15 without a filter installed are installed on the rotating wheel. The neutral density filter 12 on the rotating wheel 14 or the light-transmitting hole 15 without a filter installed thereon can be arranged in the incident light path by rotating the motor 11. Ten neutral density filters 12 with different attenuation rates and one light-transmitting hole 15 without a filter installed thereon can adjust the light transmission from 100% to one millionth of a light transmission.

In the process of detecting I₀ and detecting the original scattered light signal, the rotating wheel 14 is automatically adjusted by the motor 11, and an appropriate neutral density filter is selected to adjust the intensity of the incident laser 1, so that the transmitted light I₀ is within the linear response range of the PD detector 5, and the original scattered light 6 entering the optical fiber head 7 in the 90° optical path and the original scattered light 9 entering the optical fiber head 7 in the back optical path are within the linear response range of the APD.

The present invention also provides a method for detecting the concentration of nano-particles, comprising the following steps:
1) Collect the original scattered light signal by the APD detector, calculate the correlation function, and perform multi-exponential fitting on the correlation function to obtain the particle size intensity distribution of the particles in the sample, and by combining the wavelength of the laser, the known refractive index of the particles and the refractive index of the dispersant with Mie theory, convert the intensity distribution into volume distribution, surface area distribution and number distribution, and the corresponding distribution intensities are all relative values;
2) Calculate an average surface area diameter D_{3,2} of the sample through surface area distribution; and calculate an average particle size Dᵢ of each particle size peak through volume distribution;
3) Collect the light intensity I₀ in the transmission direction of the laser device through the blank dispersant and the light intensity I_{T} in the transmission direction after passing through the sample by the PD detector, calculate the extinction coefficient Qe through combining the laser wavelength, the known refractive index of the particles, the refractive index of the dispersant and D_{3,2} with Mie theory, and calculate the volume fraction Φ of the sample by Qe and D_{3,2} through the extinction method, the relationship between I₀, I_{T}, Qe, D_{3,2} in the extinction method is as follows:

$${I}_{T} = {I}_{0} {e}^{[ - \frac{3 R Φ {Q}_{e}}{{D}_{3 , 2}} ]}$$

wherein R refers to the half-path length of the sample pool.
4) Calculate the volume fraction Φi of each particle size peak by combining the area content of each particle size peak calculated from the volume distribution and the sample volume fraction;

Φi=Si/ΣSi*Φ
wherein Si is the area of the i-th particle size peak in the volume distribution.
5) Calculate the number concentration ρi of each particle size peak by combining the particle size Dᵢ of each particle size peak;

ρi=6*Φi/(π*Di³).

What is claimed is:

1. An optical device for detecting concentration of nano-scale particle, characterized in that: said optical device combines an extinction method and a dynamic light scattering method to detect the concentration of nanoparticles,
said optical device comprises a sample pool, a rotating wheel, an APD detector, an PD detector, a laser device, a lens, a data acquisition card, a control unit and a microprocessor having a signal input terminal receiving instructions from said control unit, and an output terminal outputting control signals connected to a motor control loop;
an incident light beam of said laser device is irradiated onto a sample in said sample pool through a neutral density filter and a lens, said neutral density filter is arranged to adjust an intensity of the incident light beam, and the lens is arranged to converge the light beam;
in a light path, neutral density filters are installed in said rotating wheel, ten number of neutral density filters with different attenuation rates and one light-transmitting hole without filter installed are installed on the rotating wheel, said neutral density filters or said light-transmitting hole without filter installed thereon of said rotating wheel is arranged in the incident light path by rotating the motor;
a scattered light signal of the sample is received by said APD detector connected to said optical fiber at 90° or backward;
said PD detector is placed in a 0° direction of laser incidence to detect an intensity of the transmitted laser.

2. The optical device for detecting concentration of nano-scale particle according to claim 1, characterized in that: said sample pool has a square or rectangular cross section, wherein opposite sides are parallel.

3. The optical device for detecting concentration of nano-scale particle according to claim 1, characterized in that: said ten neutral density filters with different attenuation rates and said one light-transmitting hole without filter installed thereon can adjust a light transmission from 100% to one millionth of the light transmission.

4. The optical device for detecting concentration of nano-scale particle according to claim 1, characterized in that: in a process of detecting I₀ and detecting the original scattered light signal, said rotating wheel is automatically adjusted by the motor to select an appropriate neutral density filter to adjust an intensity of the incident laser beam, so that the transmitted light I₀ is within a linear response range of said PD detector, and the original scattered light signal is within a linear response range of said APD.

5. A detection method applied by said optical device for detecting concentration of nano-scale particle according to claim 1, characterized in that:
Step 1: collecting the original scattered light signal by said APD detector, processing calculation of correlation function, and performing multi-exponential fitting on the correlation function to obtain a particle size light intensity distribution of the particles in the sample, and by combining a wavelength of the laser, a known refractive index of the particles and a refractive index of a dispersant with Mie theory, converting the light intensity distribution into volume distribution, surface area distribution and number distribution, and the corresponding distribution intensities are all relative values;
Step 2: calculating an average surface area diameter D_{3,2} of the sample through the surface area distribution; and calculating an average particle size Dᵢ of each particle size peak through the volume distribution;
Step 3: collecting light intensity I₀ in the transmission direction of the laser beam through a blank dispersant and light intensity I_{T} in the transmission direction after passing through the sample by said PD detector, calculating an extinction coefficient Qe through combining the laser wavelength, the known refractive index of the particles, the refractive index of the dispersant and D_{3,2} with Mie theory, and calculating a volume fraction Φ of the sample by Qe and D_{3,2} through the extinction method;
Step 4: calculating a volume fraction Φi of each particle size peak by combining the area content of each particle size peak calculated from the volume distribution and the sample volume fraction;
Step 5: calculating a number concentration of each particle size peak by combining the average particle size within each particle size peak and volume fraction of each peak.
